(19) United States
(12) Patent Application Publication
(10) Pub. No.: US 2026/0096645 A1
(43) Pub. Date: Apr. 9, 2026

(54) HOUSEHOLD ARTICLE AND MANUFACTURING METHOD THEREFOR

(71) Applicant: NEW-TEC INTEGRATION (XIAMEN) CO., LTD., Fujian (CN)

(72) Inventor: Luhao LENG, Xiamen (CN)

(21) Appl. No.: 19/113,355

(22) PCT Filed: Aug. 1, 2023
(86) PCT No.: PCT/CN2023/110605

§ 371 Date: Mar. 19, 2025

(30) Foreign Application Priority Data
Sep. 21, 2022 (CN) 202211151988.2
Sep. 21, 2022 (CN) 202222517814.5

(51) Int. Cl. A47B 13/08; A47C 7/16; A47C 7/40; B29C 51/10; B29C 51/26; B29L 31/00; B29L 31/44; E06C 7/08

(52) U.S. Cl. CPC A47B 13/08; A47C 7/16; A47C 7/40; B29C 51/10; B29C 51/267; E06C 7/08; A47B 2200/001; B29L 2031/443; B29L 2031/448; B29L 2031/745

(57) ABSTRACT

A composite board has a vacuum molded surface plate (12) and a bottom plate (13). Edges of the surface plate (12) and the bottom plate (13) are fixed into one piece by thermoplastic fixation, and a top wall of each supporting protrusion (135) and a body of the surface plate (12) are fixed into one piece by thermoplastic fixation. The composite board is formed by superimposing at least two layers of boards. A method for manufacturing the composite board provides process guidance for manufacturing the composite board.

### FIELD

The present disclosure relates to the field of furniture, and specifically to a household article and a method for manufacturing the same.

### BACKGROUND

With the increase of people's demands for materials and culture in daily life, the demands for household products is increasing. Consumers are gradually inclined to choose household products having strong functions, high stability and good outer appearance. For example, if boards used in the conventional household articles have a relatively larger thickness, the products will have better stability and visual effect, but the weight of the products will increase accordingly; if the boards have a relatively smaller thickness, the products are light-weighted and prone to break and damages.

It is proposed to provide a board with a certain thickness, good stability as well as light weight for use in household articles. However, such boards are inconvenient to manufacture because they have a certain hollow volume inside. Therefore, it is necessary to study and optimize the production process of such a novel board while proposing the novel board.

Therefore, it is desirable to provide a household article and a method for manufacturing the same, which can at least partially addresses the above problems.

### SUMMARY

A main object of the present disclosure is to provide a household article and a method for manufacturing the same. The household article according to the present disclosure comprises a composite board formed by superimposing at least two layers of boards. The resultant composite board has a certain thickness, good stability, and good comfort level of sitting, lying and stepping, which having a light weight. In addition, the present disclosure further provides a method for manufacturing the composite board, which has clear process steps, and can provide process guidance for manufacturing the composite board. With the manufacturing method according to the present disclosure, a composite board combining stability, comfort and a light weight characteristics, as well as furniture having the composite board, can be obtained. Furthermore, for the concerned composite board, the vacuum molding of the surface plate, the vacuum molding of the bottom plate and the thermoplastic fixation of the surface plate and the bottom plate into one piece can be performed simultaneously, thereby saving the processing steps and enabling the obtained composite board to have a better integrity and a more uniform and stable structure.

According to an aspect of the present disclosure, there is provided a household article comprising a composite board, the composite board comprising:
a surface plate comprising a plate-like surface plate body;
a bottom plate comprising a plate-like bottom plate body arranged at a bottom side of the surface plate body, opposed to the surface plate body and spaced apart from the surface plate body with a certain distance, and a plurality of supporting protrusions protruding from the bottom plate body toward the surface plate body,
wherein peripheral edges of the surface plate and the bottom plate are formed as one piece by thermoplastic fixation, and at least a portion of a top wall of each of the supporting protrusions and the surface plate body are also formed as one piece by thermoplastic fixation.

According to one embodiment of the present disclosure, the surface plate comprises a surface plate side body portion extending from the peripheral edge of the surface plate body towards the bottom plate, the bottom plate comprises a bottom plate side body portion extending from the peripheral edge of the bottom plate body in the same direction as the extension direction of the surface plate side body portion, and portions of the surface plate side body portion abutting against the bottom plate side body portion are formed as an integral side portion by thermoplastic fixation; or
the surface plate comprises a surface plate side body portion extending from the peripheral edge of the surface plate body towards the bottom plate, the bottom plate comprises a bottom plate side body portion extending from the peripheral edge of the bottom plate body towards the surface plate, and portions of the surface plate side body portion abutting against the bottom plate side body portion are formed as an integral side portion by thermoplastic fixation; or
the bottom plate comprises a bottom plate side body portion extending from the peripheral edge of the bottom plate body towards the surface plate, and portions of the bottom plate side body portion abutting against the peripheral edges of the surface plate body are formed as an integral side portion by thermoplastic fixation, or
the surface plate comprises a surface plate side body portion extending from the peripheral edge of the surface plate body towards the bottom plate, and portions of the surface plate side body portion abutting against the peripheral edges of the bottom plate body are formed as an integral side portion by thermoplastic fixation.

According to another embodiment of the present disclosure, the household article further comprises a reinforcing structure for supporting the composite board, the reinforcing structure supporting at least partly at the bottom side of the bottom plate.

According to a further embodiment of the present disclosure, the reinforcing structure comprises a supporting frame disposed around a peripheral edge of the composite board, and the supporting frame comprises a frame body and an engagement section formed at an edge of the frame body, wherein the engagement section is adapted with the integral side portion.

According to a further embodiment of the present disclosure, the engagement section is a stepped shape, and is supported at a bottom side of the integral side portion; or
the engagement section comprises a groove opened towards the top side and used to receive the integral side portion.

According to a further embodiment of the present disclosure, the reinforcing structure comprises supporting tube(s) located at a central position of the composite board or symmetrically disposed by taking the central position as a center of symmetry.

According to a further embodiment of the present disclosure, a bottom portion of the composite board has a recessed portion opening towards the bottom side, and the reinforcing structure is at least partially embedded in the recessed portion of the composite board.

According to a further embodiment of the present disclosure, a main body of the reinforcing structure is embedded into the recessed portion, and the reinforcing structure further comprises a groove located at the outside of the main body and used to engage with the integral side portion.

According to a further embodiment of the present disclosure, the household article further comprises a fixing frame which is provided with an opening, wherein an edge of the board of the household article can be inserted into the opening to mount the board to the fixing frame; and/or the edge of the board is a crimping structure.

According to a further embodiment of the present disclosure, the board is formed from a single board by vacuum molding.

According to a further embodiment of the present disclosure, the household article is a stool, and the composite board is at least partially formed into a seat portion of the stool; or
the household article is a table, and the composite board is at least partially formed into a desk panel of the table, wherein the desk panel is disposed at its edge a desk panel frame serving as a reinforcing structure; or
the household article is a chair, and the composite board is formed at least partially into a seat portion of the chair, wherein the chair is provided with a reinforcing structure for reinforcing the composite board, and wherein the chair further comprises a backrest frame having an opening, and an edge of a top portion of a backrest portion of the chair is inserted into the opening; or
the household article is a ladder, the composite board is at least partially formed into a step of the ladder, wherein the ladder further comprises a reinforcing structure for supporting the step.

According to another aspect of the present disclosure, there is provided a method for manufacturing the household article according to any one of the above solutions, the method comprising steps of:
heating a surface plate blank and a bottom plate blank;
placing the surface plate blank at a top side of a surface plate mold, placing the bottom plate blank at a bottom side of a bottom plate mold, and combined molding the surface plate blank and the bottom plate blank by vacuum molding process, respectively;
fixing the surface plate blank and the bottom plate blank together by thermoplastic fixation.

According to one embodiment of the present disclosure, the step of combined molding the surface plate blank and the bottom plate blank by vacuum molding process comprises:
arranging a material pressing frame between the surface plate blank and the bottom plate blank to space the surface plate blank and the bottom plate blank apart; or
inflating air between the surface plate blank and the bottom plate blank during the process of vacuum molding to form a gap between the surface plate blank and the bottom plate blank.

According to another embodiment of the present disclosure, the step of combined molding the surface plate blank and the bottom plate blank by vacuum molding and the step of fixing the surface plate blank and the bottom plate blank together by thermoplastic fixation are performed simultaneously; or
re-heating the surface plate blank and the bottom plate blank to fix them together after the step of combined molding the surface plate blank and the bottom plate blank by vacuum molding process.

### BRIEF DESCRIPTION OF THE DRAWINGS

Reference may be made to preferred embodiments shown in the figures to enable better understanding of the above and other objects, features, advantages and functions of the present disclosure. The same reference numerals in the figures denote the same parts. Those skilled in the art should appreciate that the figures are intended to schematically illustrate the preferred embodiments of the present disclosure, and not intended to impose any limitations to the scope of the present disclosure. All parts in the figures are not drawn to scale.

FIG. 1 shows a household article which is a high-legged stool according to a preferred embodiment of the present disclosure;

FIG. 2A is a top view of a seat portion of the high-legged stool in FIG. 1.

FIG. 2B is a bottom view of the seat portion in FIG. 2A;

FIG. 3A is a cross-sectional view taken along line A-A in FIG. 2A;

FIG. 3B is a partially enlarged view of a portion B of FIG. 3A;

FIG. 4 is a bottom view of the seat portion of FIG. 2B, and also shows a reinforcing structure for supporting the seat portion;

FIG. 5 shows the household article which is a foldable table according to another preferred embodiment of the present disclosure.

FIG. 6A-FIG. 6D are several possible configurations of a partially enlarged view of portion C of FIG. 5;

FIG. 7 shows a household article which is a foldable chair according to a further preferred embodiment of the present disclosure.

FIG. 8 is an exploded view of the leg and the backrest of the foldable chair in FIG. 7, showing some cross-sectional portions in a partially enlarged manner;

FIG. 9A is an assembled view of the leg and the backrest of the foldable chair in FIG. 7;

FIG. 9B is a partially enlarged view of a portion D of FIG. 9A;

FIG. 10 is a schematic view of a composite board of the seat portion and its reinforcing structure of the foldable chair in FIG. 7;

FIG. 11A is a partial view of the cross-sectional view of FIG. 10;

FIG. 11B is a partially enlarged view of a portion E of FIG. 11A;

FIG. 12 shows a household article which is a ladder according to a further preferred embodiment of the present disclosure;

FIG. 13A is a cross-sectional view of a step of the ladder of FIG. 12 taken along line F-F;

FIG. 13B is a partially enlarged view of portion H in FIG. 13A;

FIG. 14A is a cross-sectional view of a step of the ladder of FIG. 12 taken along line G-G;

FIG. 14B is a partially enlarged view of a portion I of FIG. 14A;

FIG. 15 and FIG. 16 are a flow chart of a method for manufacturing a composite board of a household article according to a preferred embodiment of the present disclosure;

FIG. 17 is a flow chart of a method for manufacturing a composite board of a household article according to another preferred embodiment of the present disclosure.

### DETAILED DESCRIPTION OF EMBODIMENTS

Specific embodiments of the present disclosure will now be described in detail with reference to the figures. What are described herein are only preferred embodiments of the present disclosure. Those skilled in the art may implement other manners of the present disclosure on the basis of the preferred embodiments, and said other manners also fall within the scope of the present disclosure.

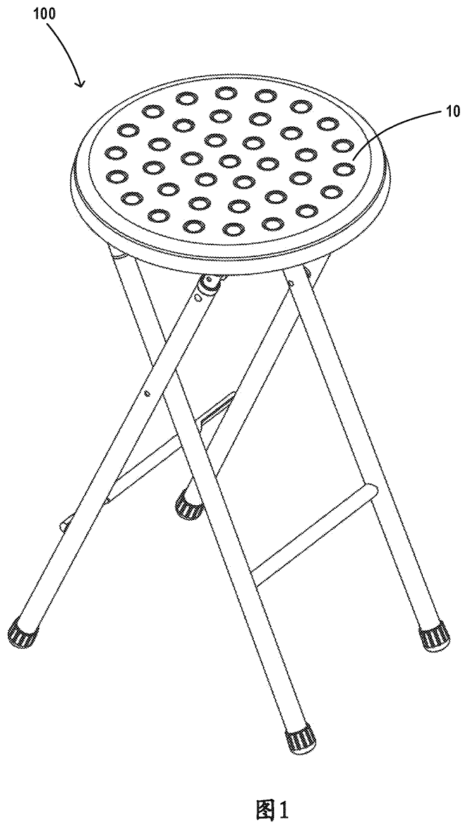

The present disclosure provides a household article and a method for manufacturing the same. FIG. 1 through FIG. 17 illustrate some preferred embodiments of the present disclosure. Firstly, it needs to be appreciated that directional terms and positional terms mentioned in the present disclosure may be understood with reference to the embodiments shown in FIG. 1 through FIG. 4. The directional terms and positional terms mentioned in the present disclosure all indicate relative directions and positions other than absolution directions and positions of all parts. For example, “a top portion” and “a top side” of a part may be understood as the top portion and top side of the part when the household article is placed correctly on a horizontal plane and in an in-use state; “a bottom portion” and “a bottom side” of a part may be understood as the bottom portion and bottom side of the part when the household article is placed correctly on the horizontal plane and in an in-use state.

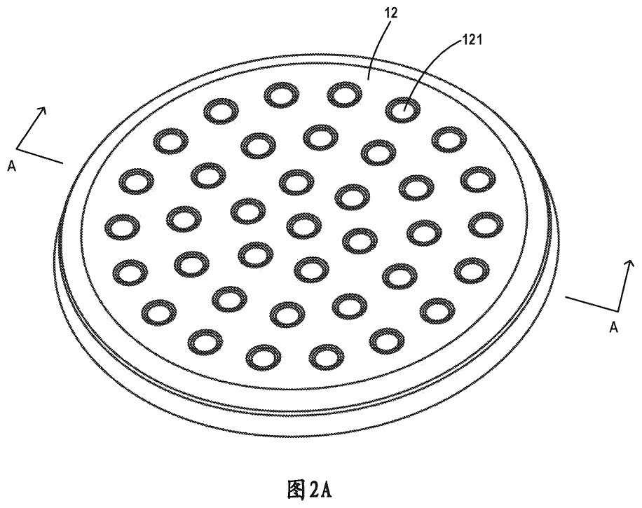

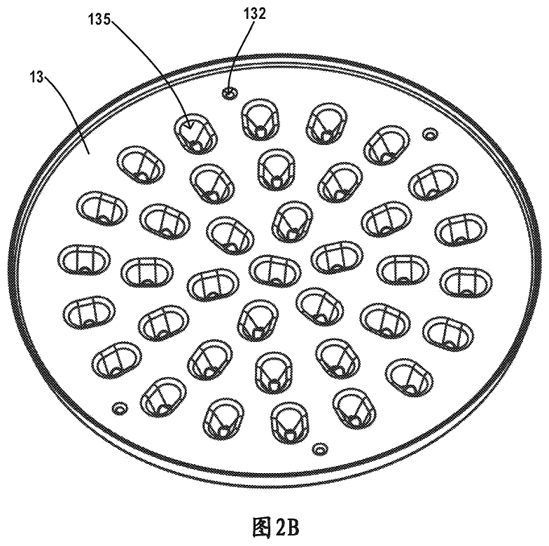

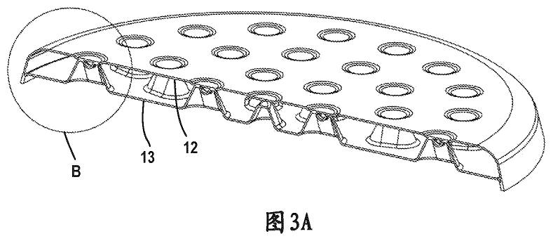

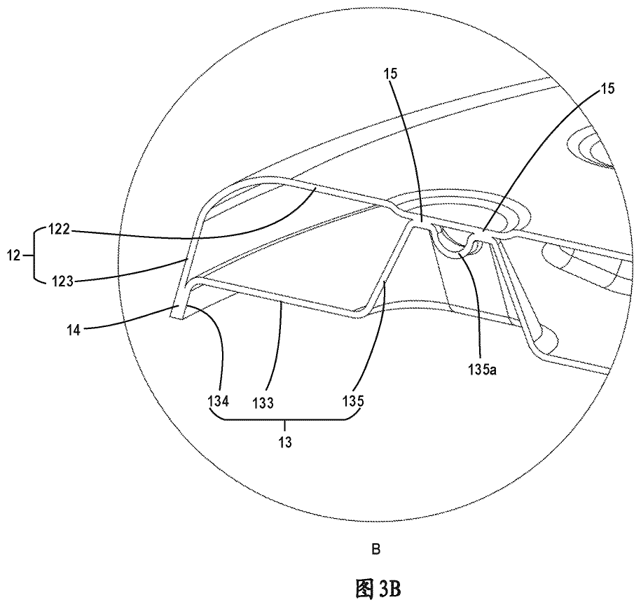

FIG. 1 through FIG. 4 show a household article according to the present disclosure. The household article is, for example, a high-legged stool 100, particularly a bar stool. The stool 100 may also have shorter legs to serve as a stool with an ordinary height, or a child stool. The high-legged stool 100 comprises legs and a seat portion 10 which is formed at least in part from a composite board. FIG. 2A is a schematic view of a top surface of the composite board of the seat portion 10, and FIG. 2B is a schematic view of a bottom surface of the composite board of the seat portion 10. FIG. 3A and FIG. 3B are cross-sectional views of the composite board shown in FIG. 2A, and clearly show the composition and detailed form of the composite board.

Referring to FIG. 3A and FIG. 3B, the composite board comprises a surface plate 12 and a bottom plate 13. The surface plate 12 comprises a flat plate-like surface plate body 122, and a circumferential surface plate side body portion 123 extending from a circumferential edge of the surface plate body 122 toward a bottom side. A top portion of the surface plate body 122 has a plurality of anti-slip blocks or anti-slip recesses 121 arranged in an array. The bottom plate 13 is arranged at a bottom side of the surface plate body 122. The bottom plate 13 comprises a flat plate-like bottom plate body 133, a plurality of supporting protrusions 135 protruding from the bottom plate body 133 toward a top side, and a circumferential bottom plate side body portion 134 extending from a circumferential edge of the bottom plate body 133 toward the bottom side. The bottom portion of the bottom plate body 133 has screw holes 132. As can be seen from FIG. 3A, the plurality of supporting protrusions 135 constitute a substantially honeycomb-shaped structure.

The surface plate 12 and the bottom plate 13 are fixed as one piece by thermoplastic fixation. Portions of the surface plate 12 and bottom plate 13 which are adhered as one piece by thermoplastic fixation are respectively formed at the bottom portion of the side wall and the top portions of the supporting protrusions 135. For example, referring to FIG. 3B, the bottom portion of the surface plate side body portion 123 and the bottom plate side body portion 134 are fixed as one piece by thermoplastic fixation and form an integral side portion 14 so that the surface plate 12 and bottom plate 13 engages with each other at the integral side portion 14. Meanwhile, a top wall of each of the supporting protrusions 135 and the surface plate body 122 are fixed as one piece by thermoplastic fixation. Furthermore, the top wall of the supporting protrusion 135 includes a top adhesion portion 15, which is adhered to the surface plate body 122 by thermoplastic fixation. For each of the supporting protrusions 135, the top adhesion portion 15 is disposed around a center of the top of the supporting protrusion 135. The center of the top sinks to constitute a recessed portion 135a. The top adhesion portion 15, the recessed portion 135a and the surface plate body 122 jointly define a small cavity.

It can be seen that the composite board in the present embodiment has a certain thickness, which may be, for example, a height of the surface plate side body portion 123. In another aspect, due to the provision of the supporting protrusions 135, the integral side portion 14 as well as the top adhesion portion 15, the composite board has better strength and stability, is not prone to deformation and collapse in use, and parts are not apt to disengagement from one another. In a further aspect, many cavity structures are disposed in the composite board, for example, the cavity jointly defined by the side wall of the supporting protrusion 135, the surface plate body 122, the surface plate side body portion 135a and the bottom plate body 133; the cavity jointly defined by the top adhesion portion 15, the recessed portion 135a and the surface plate body 122; and the cavity defined by the side wall and the top wall of the supporting protrusion 135 (the cavity has an opening facing downwardly). The arrangement of these cavities enables the composite board as a whole to have a light weight for convenient storage and transportation.

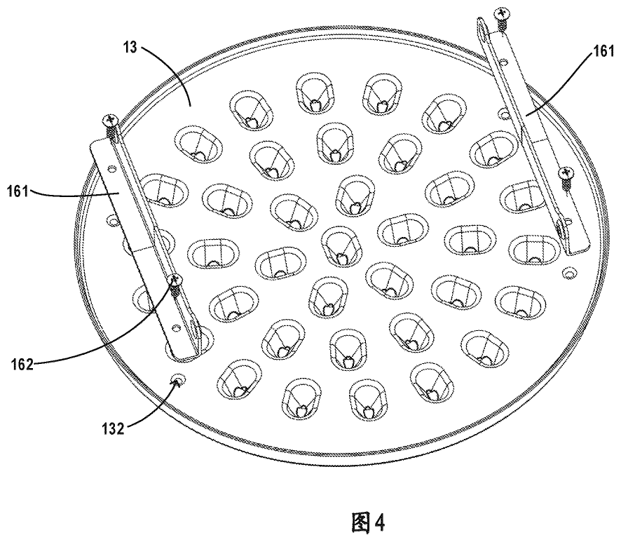

FIG. 4 illustrates a composite board and a reinforcing structure at the bottom side of the composite board, and the reinforcing structure supports at least partly at the bottom side of the bottom plate 13. The reinforcing structure is configured as, for example, two elongated rib plates 161 with each having an L-shaped cross section. The reinforcing structure is secured to the bottom portion of the composite board by fasteners such as screws 162.

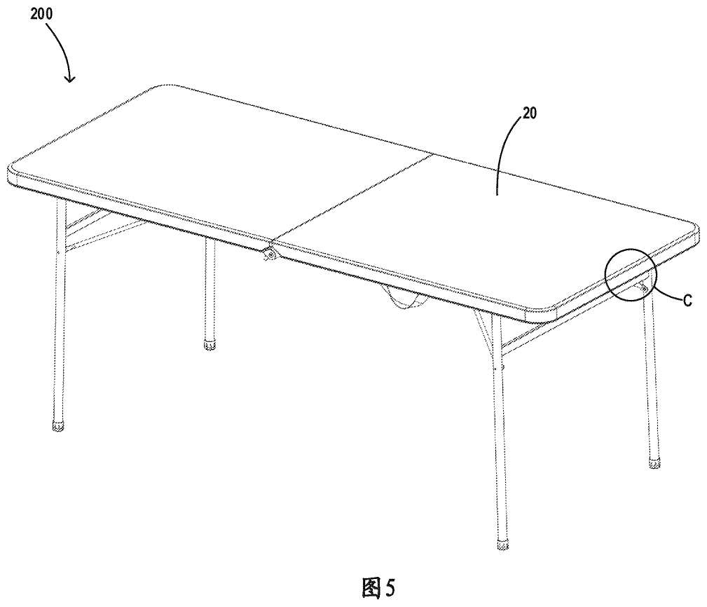

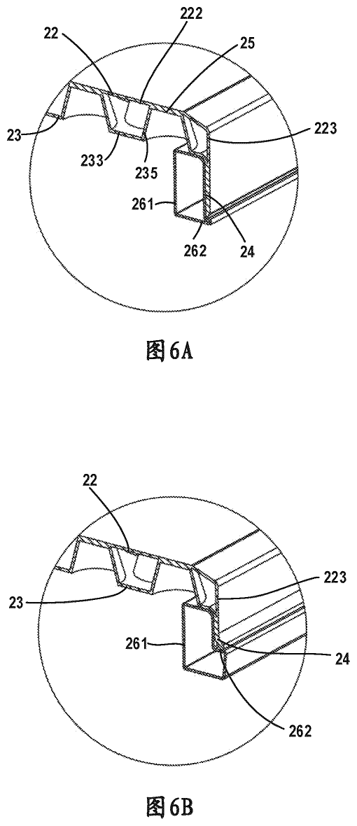

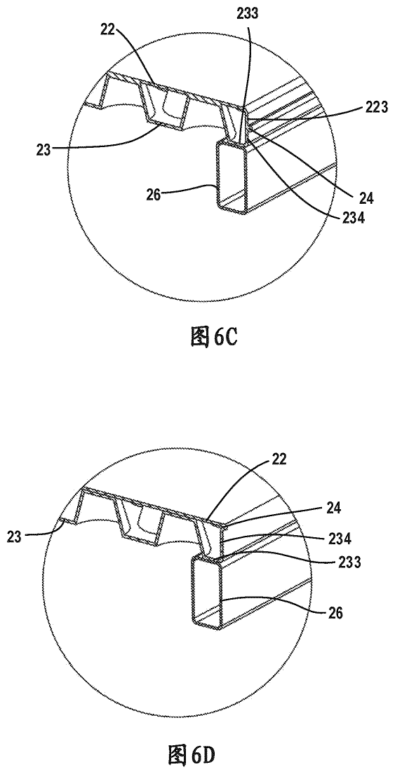

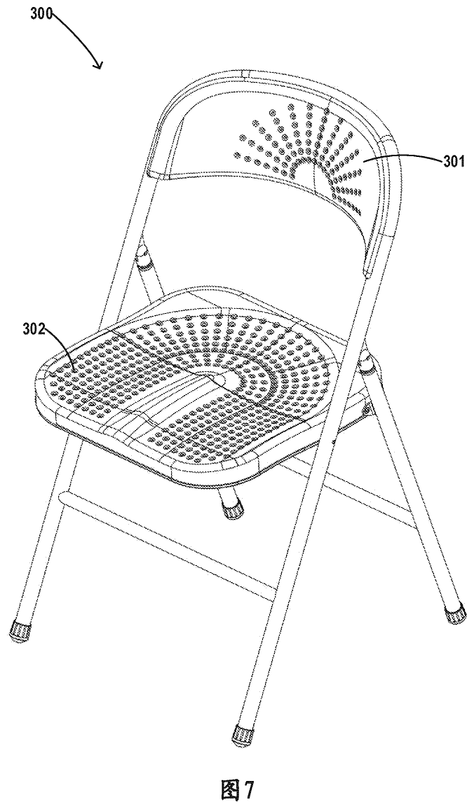

FIG. 5 through FIG. 6D illustrate another preferred embodiment according to the present disclosure. The preferred embodiment further comprises a plurality of possible structural variants.

In the present embodiment, the household article is a foldable table 200 having two desk panels 20 that are foldable relative to each other, and each of the desk panels 20 may comprise a composite board. Alternatively, the foldable table may also be replaced by another type of table, which may have only one composite board or a plurality of composite boards that are not foldable with respect to each other. The foldable table further has a peripheral reinforcing frame disposed at the peripheral edge of the composite board to act as a reinforcing structure. FIG. 6A and FIG. 6D illustrate several configurations of the composite board and several possible embodiments where the composite board cooperates with the reinforcing frame. In FIG. 6A through FIG. 6D, the composite board comprises a surface plate and a bottom plate which are fixed as one piece by thermoplastic fixation.

Referring first to FIG. 6A, the surface plate 22 comprises a flat plate-like surface plate body 222, and a peripheral surface plate side body portion 223 extending from an edge of the surface plate body 222 towards a bottom side; the bottom plate 23 comprises a bottom plate body 233, a plurality of supporting protrusions 235 protruding from the bottom plate body 233 towards the top side, and a peripheral bottom plate side body portion extending from an edge of the bottom plate body 233 towards to the bottom side. The surface plate side body portion 233 and the bottom plate side body portion are fixed as one piece by thermoplastic fixation and form an integral side portion 24. A top wall of the supporting protrusion 235 of the bottom plate 23 is a flat plate-type structure. The top wall of the supporting protrusion 235 abuts against the surface plate body 222.

In FIG. 6A, the reinforcing frame comprises a frame body 261 and an engagement section 262 formed at an edge of the frame body 261, the engagement section 262 being adapted with the integrated side edge 24. Furthermore, the engagement section 262 is a stepped structure supporting the bottom side of the integral side portion 24 such that an outside surface of the frame body 261 abuts against an inside surface of the integral side portion 24. The reinforcing frame has a substantially hollow rectangular cross-section, and its bottom end on the outer side may be formed by extrusion to obtain the stepped structure. That is, the engaging section 262 of the present embodiment may be a thin edge protruding from the lowermost portion of a side surface of the frame body 261. The composite board may engage with the engagement section of the reinforcing frame by welding or by connection using fasteners.

Referring to FIG. 6B, the surface plate 22 comprises a flat plate-like surface plate body, and a peripheral surface plate side body portion 223 extending from an edge of the surface plate body toward a bottom side; the bottom plate 23 comprises a flat plate-like bottom plate body, and a peripheral bottom plate side body portion extending from the edge of the bottom plate body toward the bottom side. The surface plate side body portion 223 and the bottom plate side body portion are fixed as one piece by thermoplastic fixation and form an integral side portion 24. A top wall of the supporting protrusion of the bottom plate 22 is a flat plate-type structure. The top wall of the supporting protrusion abuts against the surface plate body.

In FIG. 6B, the reinforcing frame comprises a frame body 261 and an engagement section 262 formed at an edge of the frame body 261, the engagement section 262 being adapted with the integrated side edge 24. Furthermore, the engagement section 262 is configured as a stepped structure. For example, the frame has a substantially hollow L-shaped profile whose corner is formed into the stepped structure. It can be seen that in the present embodiment the stepped structure also has a certain thickness. The composite board may engage with the engagement section of the reinforcing frame by welding or by connection using fasteners.

Referring to FIG. 6C, the surface plate 22 comprises a flat plate-like surface plate body, and a peripheral surface plate side body portion 223 extending from an edge of the surface plate body toward a bottom side; the bottom plate 23 comprises a bottom plate body 233, and a peripheral bottom plate side body portion extending from the edge of the bottom plate body 233 toward a top side. The surface plate side body portion 223 and the bottom plate side body portion 234 are fixed as one piece by thermoplastic fixation and form an integral side portion 24. A top wall of the supporting protrusion of the bottom plate 23 is a flat plate-type structure. The top wall of the supporting protrusion abuts against the surface plate body.

In FIG. 6C, the top portion of the reinforcing frame 26 is adapted with the composite board. The reinforcing frame 26 is formed as a hollow structure having a rectangular cross section. The rectangular structure does not have any edge or step extending outward. The top portion of the reinforcing frame 26 supports the composite board. Specifically, the top wall of the reinforcing frame 26 supports the bottom plate body 233. The composite board may engage with the reinforcing frame 26 by welding or by connection using fasteners.

Referring to FIG. 6D, the bottom plate 23 comprises a bottom plate body 233, and a peripheral bottom plate side body portion 234 extending from an edge of the bottom plate body 233 towards a top side. The surface plate 22 and the bottom plate side body portion 234 are fixed as one piece by thermoplastic fixation and form an integral side portion 24. A top wall of the supporting protrusion of the bottom plate 23 is a flat plate-type structure. The top wall of the supporting protrusion abuts against the surface plate body.

In FIG. 6D, the top portion of the reinforcing frame 26 is adapted with the composite board. The reinforcing frame 26 is formed as a hollow structure having a rectangular cross section. The rectangular structure does not have any edge or step extending outward. The top portion of the reinforcing frame 26 supports the composite board. Specifically, the top wall of the reinforcing frame 26 supports the bottom plate body 233. The composite board may engage with the reinforcing frame 26 by welding or by connection using fasteners.

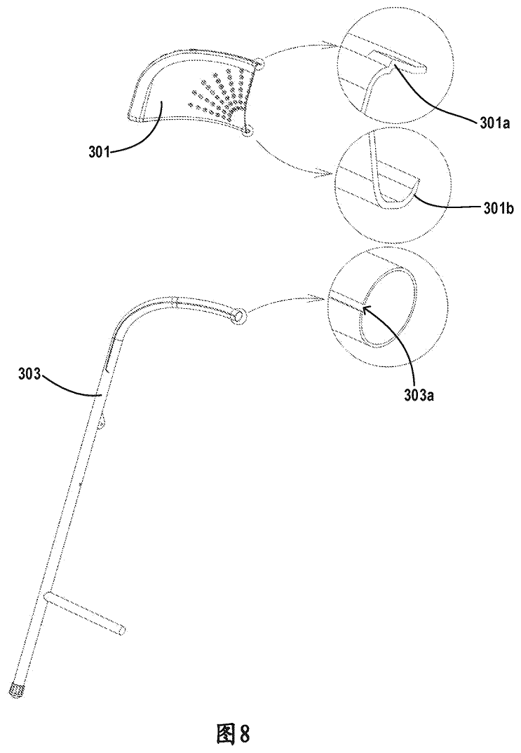

FIG. 7 through FIG. 11B illustrate a further embodiment according to the present disclosure. In the embodiment, the household article is a chair 300, such as a foldable chair or a non-foldable chair. The chair comprises a seat portion 302 and a backrest portion 301.

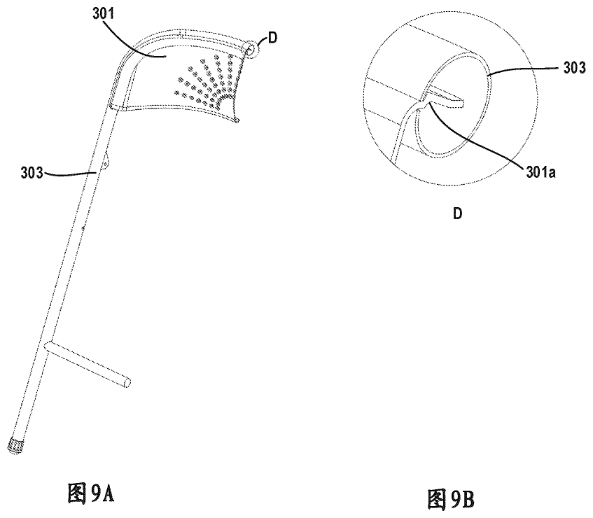

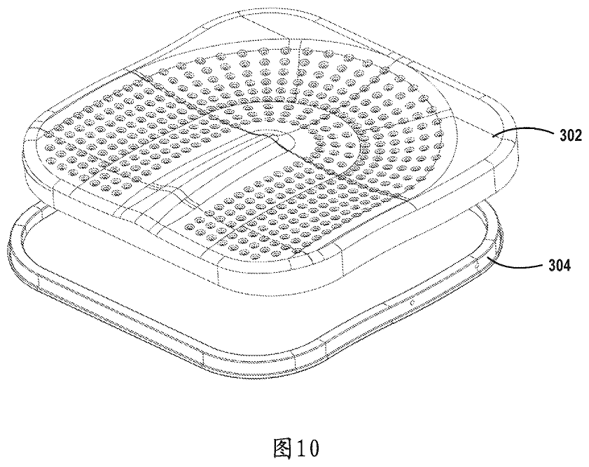

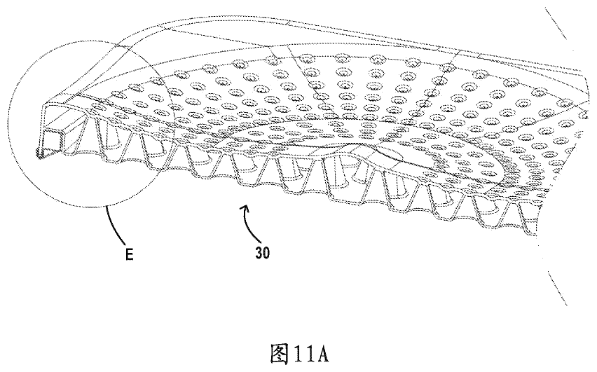

Referring to FIG. 8 through FIG. 9B, the chair 300 has a backrest frame 303 (an example of a fixed frame) having an opening 303a, the backrest frame 303 may be integral with legs of the chair, and the opening 303a on the backrest frame extends along tubing that forms backrest frame 303. A top wall of the board constituting the backrest portion 301 has an insert 301a to be inserted into the opening 303a of the backrest frame 303. The insert 301a may be provided with small protrusions to prevent the insert 301a from disengaging from the opening 303a. A bottom wall of the board constituting the backrest portion 301 is an upwardly turned bead 301b, which is exposed to the external. In some embodiments, the backrest portion 301 may be constructed of the composite board according to the present disclosure.

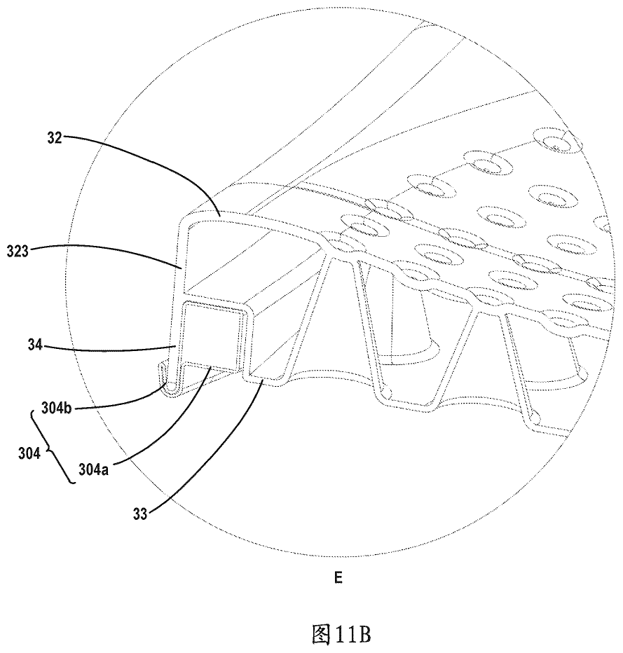

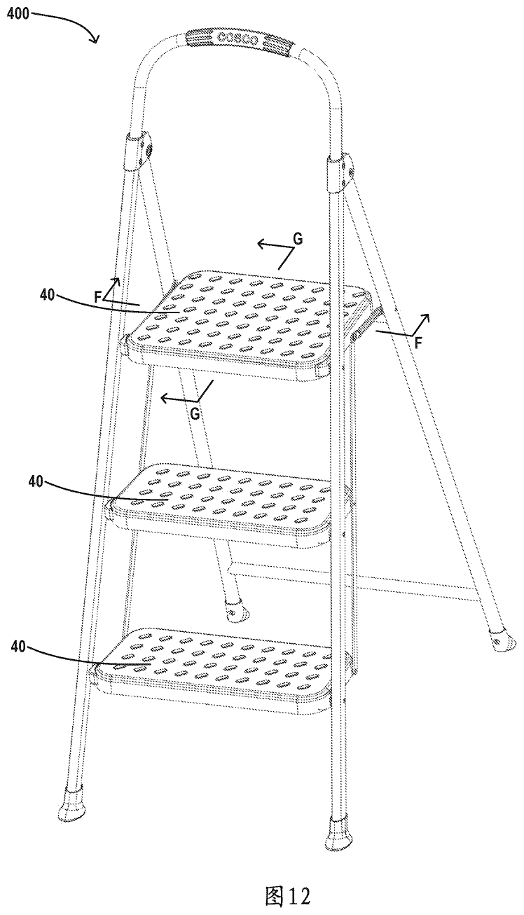

Referring to FIG. 10 through FIG. 11B, the seat portion 302 of the chair is constructed of the composite board. The chair comprises a reinforcing structure 304 for reinforcing the composite board. The composite board comprises a bottom plate 33 and a surface plate 32. The surface plate 32 comprises a flat plate-like surface plate body, and a peripheral surface plate side body portion 323 extending from an edge of the surface plate body toward a bottom side. The surface plate side body portion 323 and the bottom plate 33 are fixed as one piece by thermoplastic fixation and form an integral side portion 34. Preferably, a recessed portion recessed towards the top is disposed between the bottom plate 33 and the integral side portion 34 (i.e., at the most marginal position of the bottom plate), i.e., the recessed portion has an opening facing towards the bottom side. The reinforcing structure 304 is at least partially embedded in the recessed portion. The reinforcement structure 304 comprises, for example, a reinforcing tube 304a. The reinforcing structure 304 further comprises a groove 304b located at the edge of the reinforcing tube 304a and opening towards the top side to receive the integral side portion 34.

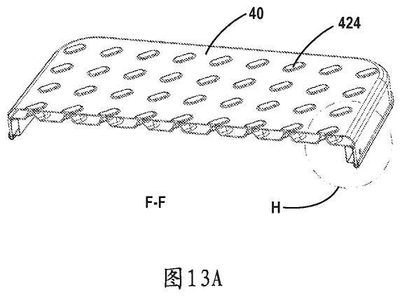

FIG. 12 through FIG. 14B illustrate a further embodiment according to the present disclosure. The household article in this embodiment is a ladder 400 whose steps 40 are at least partially constructed of a composite board.

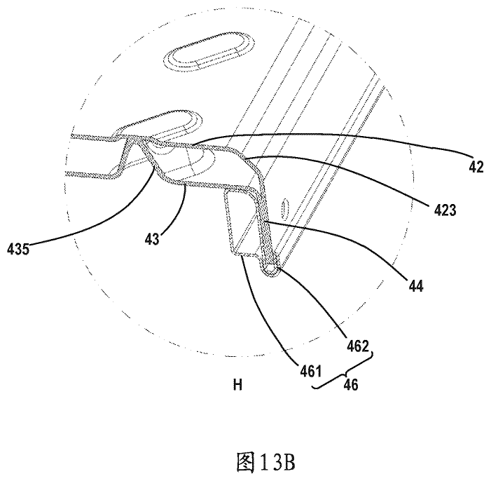

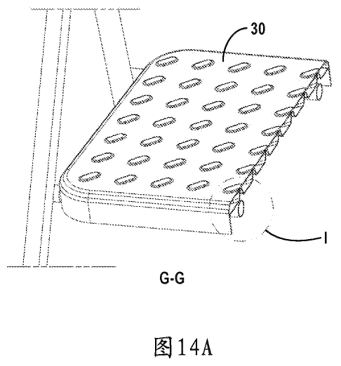

Referring to FIG. 13A and FIG. 13B, the composite board comprises a surface plate 42 and a bottom plate 43. The surface plate 42 comprises a flat plate-like surface plate body, and a peripheral surface plate side body portion 423 extending from an edge of the surface plate body toward a bottom side. The top portion of the surface plate body is provided with a plurality of anti-slip blocks 424 arranged in an array. The bottom plate 43 comprises a bottom plate body, and a peripheral bottom plate side body portion extending from an edge of the bottom plate body toward the bottom side. The surface plate side body portion 423 and the bottom plate side body portion are fixed as one piece by thermoplastic fixation and form an integral side portion 44.

The ladder 400 further comprises a reinforcing structure for supporting the composite board, the reinforcing structure including a peripheral reinforcing frame 46 located at the edge of the composite board. The reinforcing frame 46 comprises a frame body 461 and an engagement section 462 formed at an edge of the frame body 461. The engagement section 462 is adapted with the integral side portion 44. Specifically, the engagement section 462 comprises a groove opening towards the top side to receive the integral side portion 44.

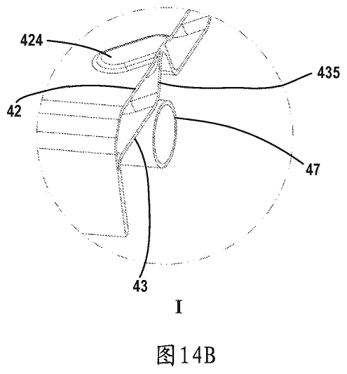

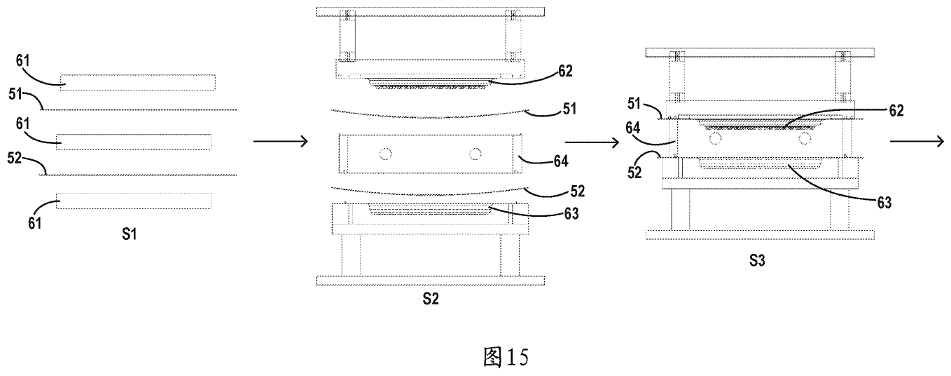

Referring to FIG. 14A and FIG. 14B, the reinforcing structure further comprises supporting tube(s) 47 located at or near a central position of the composite board. For example, the supporting tubes 47 may be symmetrically disposed by taking the central position as a center of symmetry. As shown in FIG. 14B, the bottom plate 43 comprises a plurality of supporting protrusions 435 protruding from the bottom plate body toward the top side, the surface plate 42 and the bottom plate 43 are fixed at the edges as one piece by thermoplastic fixation, and the top wall of each of the supporting protrusions and the surface plate body are fixed as one piece by thermoplastic fixation.

Especially, regarding the composite board in each of the above embodiments, the vacuum molding of the surface plate, the vacuum molding of the bottom plate, and the thermoplastic fixation of the surface plate and the bottom plate into one piece can be performed simultaneously, thereby saving the processing steps and enabling the composite board obtained from the processing to have better integrity and a more uniform and stable structure.

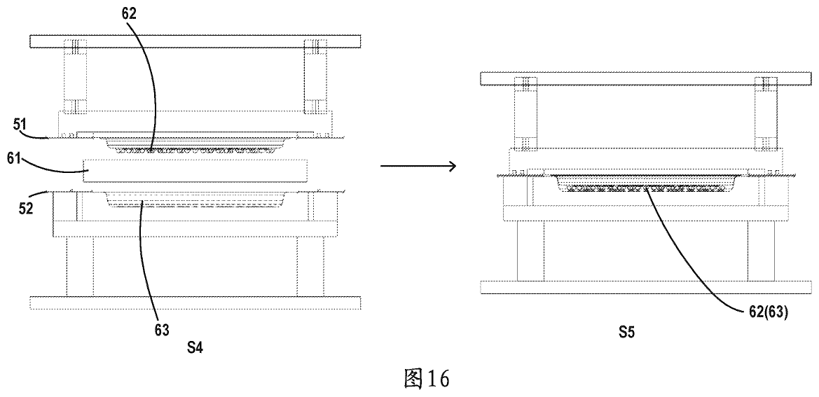

The present disclosure further provides a method of manufacturing the household article according to the above embodiments, the method comprising steps of manufacturing a composite board. The steps of manufacturing the composite board will be described with reference to a manufacturing apparatus shown in FIG. 15 through FIG. 17.

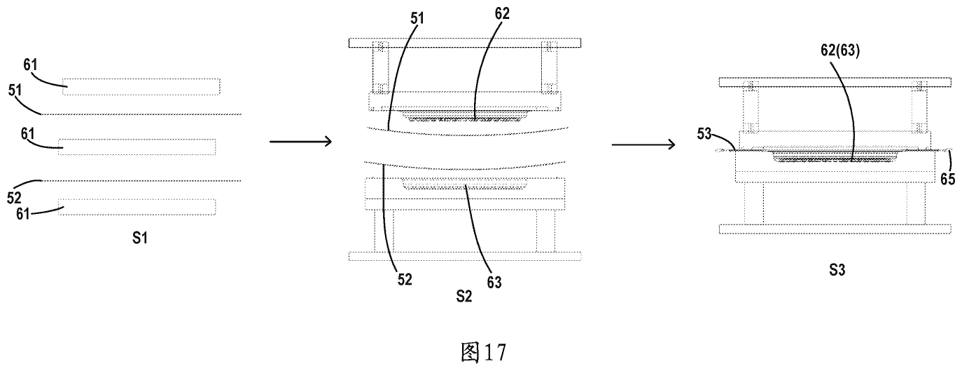

Referring first to FIG. 15 to FIG. 16, in step S1, a surface plate blank 52 and a bottom plate blank 51 are first placed at a heating device 61, respectively, so that they are heated to have a certain plasticity. In steps S2 and S3, the heated bottom plate blank 51 is placed below a bottom plate vacuum molding mold 62, and the heated surface plate blank 52 is placed above the surface plate vacuum molding mold 63, so that the surface plate blank 52 and the bottom plate blank 51 are respectively formed by combined molding. A material pressing frame 64 is placed between the bottom plate blank 51 and the surface plate blank 52 to prevent the surface plate blank 52 and the bottom plate blank 51 from being thermoplastically fixed as one piece in this step. As can be seen in FIG. 15, a bottom plate vacuum molding mold 62 has a plurality of raised portions projecting downwardly, and the bottom plate vacuum-molded via the bottom plate vacuum-molding mold 62 will have a plurality of supporting protrusions protruding towards the surface plate.

After the surface plate blank 52 and the bottom plate blank 51 are respectively vacuum molded, the process proceeds to step S4. In step S4, the surface plate blank 52 and bottom plate blank 51 are respectively heated. For example, the heating device 61 may be placed between the surface plate blank 52 and the bottom plate blank 51. The heating device 61 heats the surface plate blank 52 and the bottom plate blank 51 simultaneously. After re-heating, the process proceeds to step S5, wherein the surface plate blank 52 and the bottom plate blank 51 are superimposed so that the two are theremoplastically fixed as one piece.

FIG. 17 illustrates another apparatus and method for making a composite board. Referring to FIG. 17, in step S1, first the surface plate blank 52 and the bottom plate blank 51 are respectively placed at the heating device 61 so that they are heated to have a certain plasticity. Then, the process proceeds to steps S2 and S3. In steps S2 and S3, the surface plate blank 52 and bottom plate blank 51 are directly superimposed, and vacuum-molded from the surface plate vacuum molding mold 63 and the bottom plate vacuum molding mold 62, respectively, and meanwhile the surface plate blank 52 and the bottom plate blank 51 are fixed as one piece via the thermoplasticity. That is to say, in this method, the step of vacuum molding the surface plate blank 52 and bottom plate blank 51 and the step of thermoplastically fixing them into one piece occur simultaneously. In order to avoid excessive adhesion of the surface plate blank 52 and bottom plate blank 51 (the excessive adhesion for example includes the adhesion of the surface plate body of the surface plate and the bottom plate body of the bottom plate), in step S3, an inflation tube 53 and an inflation tube 65 are used to inflate air between the surface plate blank 52 and the bottom plate blank 51 so that the surface plate and the bottom plate can be adhered together only at a predetermined position. The adhesion at the predetermined position is, for example, the adhesion between the supporting protrusions of the bottom plate and the surface plate body, and the adhesion between the surface plate side body portion and the bottom plate side body portion. Due to the presence of the inflation tubes, the surface plate body and the bottom plate body are still spaced apart, and the composite board still has an ideal thickness, stability and weight.

The household article according to the present disclosure comprises a composite board formed by superimposing at least two layers of boards. The composite board has a certain thickness, good stability, and good comfort level of sitting, lying and stepping, as well as a light weight. In addition, the present disclosure further provides a method for manufacturing the composite board. The method has clear process steps, and can provide process guidance for manufacturing the composite board. With the manufacturing method according to the present disclosure, a composite board combining stability, comfort and a light weight characteristic, as well as furniture having the composite board, can be obtained. Furthermore, for the concerned composite board, the vacuum molding of the surface plate, the vacuum molding of the bottom plate and the thermoplastic molding of the surface plate and the bottom plate into one piece can be performed simultaneously, thereby saving the processing steps and enabling the obtained composite board to have a better integrity and a more uniform and stable structure.

The above depictions of various embodiments of the present disclosure are provided to those having ordinary skill in the art for depiction purpose, and are not intended to exclude other embodiments from the present disclosure or limit the present disclosure to a single disclosed embodiment. As described above, various alternatives and variations of the present disclosure will be apparent to those having ordinary skill in the art as taught above. Accordingly, although some alternative embodiments have been described in detail, those having ordinary skill in the art will understand or readily develop other embodiments. The present disclosure is intended to cover all alternatives, modifications and variations of the present disclosure described herein, as well as other embodiments falling within the spirit and scope of the present disclosure described above.

1. A household article comprising a composite board, wherein the composite board comprises:
a surface plate (12) comprising a plate-like surface plate body (122);
a bottom plate (13) comprising a plate-like bottom plate body (133) arranged at a bottom side of the surface plate body (122), opposed to the surface plate body and spaced apart from the surface plate body with a certain distance, and a plurality of supporting protrusions (135) protruding from the bottom plate body toward the surface plate body (122),
wherein the surface plate (12) and the bottom plate (13) are respectively formed by vacuum molding, peripheral edges of the surface plate (12) and the bottom plate (13) are formed as one piece by thermoplastic fixation, and at least a portion of a top wall of each of the supporting protrusions (135) and the surface plate body (122) are also formed as one piece by thermoplastic fixation.

2. The household article according to claim 1, wherein the surface plate (22) comprises a surface plate side body portion (223) extending from the peripheral edge of the surface plate body (222) towards the bottom plate (13), the bottom plate (23) comprises a bottom plate side body portion extending from the peripheral edge of the bottom plate body (233) in the same direction as an extension direction of the surface plate side body portion (223), and portions of the surface plate side body portion abutting against the bottom plate side body portion are formed as an integral side portion (24) by thermoplastic fixation; or
the surface plate comprises a surface plate side body portion extending from the peripheral edge of the surface plate body towards the bottom plate, the bottom plate comprises a bottom plate side body portion extending from the peripheral edge of the bottom plate body towards the surface plate, and portions of the surface plate side body portion abutting against the bottom plate side body portion are formed as an integral side portion by thermoplastic fixation; or
the bottom plate comprises a bottom plate side body portion extending from the peripheral edge of the bottom plate body towards the surface plate, and portions of the bottom plate side body portion abutting against the peripheral edges of the surface plate body are formed as an integral side portion by thermoplastic fixation, or
the surface plate comprises a surface plate side body portion extending from the peripheral edge of the surface plate body towards the bottom plate, and portions of the surface plate side body portion abutting against the peripheral edges of the bottom plate body are formed as an integral side portion by thermoplastic fixation.

3. The household article according to claim 2, wherein the household article further comprises a reinforcing structure (161, 26, 304, 46, 47) for supporting the composite board, the reinforcing structure supporting at least partly at the bottom side of the bottom plate.

4. The household article according to claim 3, wherein the reinforcing structure comprises a supporting frame disposed around a peripheral edge of the composite board, and the supporting frame comprises a frame body (261, 304a, 461) and an engagement section (262, 304b, 462) formed at an edge of the frame body, wherein the engagement section (262, 304b, 462) is adapted with the integral side portion (24).

5. The household article according to claim 4, wherein the engagement section (262) is step-shaped, and is supported at a bottom side of the integral side portion; or
the engagement section (304b, 462) comprises a groove opened towards the top side and used to receive the integral side portion (34, 44).

6. The household article according to claim 4, wherein the reinforcing structure comprises supporting tube(s) (47) located at a central position of the composite board or symmetrically disposed by taking the central position as a center of symmetry.

7. The household article according to claim 3, wherein a bottom portion of the composite board has a recessed portion opening towards the bottom side, and the reinforcing structure is at least partially embedded in the recessed portion of the composite board.

8. The household article according to claim 7, wherein a main body (304a) of the reinforcing structure (304) is embedded into the recessed portion, and the reinforcing structure further comprises a groove (304b) located at the outside of the main body (304a) and used to engage with the integral side portion (34).

9. The household article according to claim 1, wherein the household article further comprises a fixing frame (303) which is provided with an opening (303a), and an edge of the board of the household article is configured to be inserted into the opening (303a) to mount the board to the fixing frame; and/or the edge of the board is a crimping structure.

10. The household article according to claim 9, wherein the board is formed from a single board by vacuum molding.

11. The household article according to claim 1, wherein the vacuum molding of the surface plate, the vacuum molding of the bottom plate, and the thermoplastic fixation of the surface plate and the bottom plate into one piece are performed simultaneously.

12. The household article according to claim 1, wherein the household article is a stool, and the composite board is at least partially formed into a seat portion of the stool; or
the household article is a table, and the composite board is at least partially formed into a desk panel of the table, wherein the desk panel is disposed at its edge a desk panel frame serving as a reinforcing structure; or
the household article is a chair, and the composite board is at least partially formed into a seat portion of the chair, wherein the chair is provided with a reinforcing structure for reinforcing the composite board, and wherein the chair further comprises a backrest frame having an opening, and an edge of a top portion of a backrest portion of the chair is inserted into the opening; or
the household article is a ladder, the composite board is at least partially formed into a step of the ladder, wherein the ladder further comprises a reinforcing structure for supporting the step.

13. A method for manufacturing the household article comprising the steps of:
heating a surface plate blank (52) and a bottom plate blank (51);
placing the surface plate blank (52) at a top side of a surface plate mold (63), placing the bottom plate blank (51) at a bottom side of a bottom plate mold (62), and combined molding the surface plate blank and the bottom plate blank by vacuum molding process, respectively;
fixing the surface plate blank and the bottom plate blank together by thermoplastic fixation.

14. The method according to claim 13, wherein the step of combined molding the surface plate blank and the bottom plate blank by vacuum molding process comprises:
arranging a material pressing frame (64) between the surface plate blank and the bottom plate blank to space the surface plate blank and the bottom plate blank apart; or
inflating air between the surface plate blank and the bottom plate blank during the process of vacuum molding to form a gap between the surface plate blank and the bottom plate blank.

15. The method according to claim 13, wherein the step of combined molding the surface plate blank and the bottom plate blank by vacuum molding and the step of fixing the surface plate blank and the bottom plate blank together by thermoplastic fixation are performed simultaneously; or
re-heating the surface plate blank and the bottom plate blank to fix them together after the step of combined molding the surface plate blank and the bottom plate blank by vacuum molding process.
